(19) United States
(12) Patent Application Publication
(10) Pub. No.: US 2002/0158461 A1
(43) Pub. Date: Oct. 31, 2002

(54) Easy fold jig

(76) Inventor: Frank Fusco, Schaefferstown, PA (US)

Correspondence Address: FRANK FUSCO, P.O. BOX 193, SCHAEFFERSTOWN, PA, 17088, US

(21) Appl. No.: 09/960,145

(22) Filed: Sep. 24, 2001

Related U.S. Application Data
(60) Provisional application No. 60/287,296, filed on Apr. 30, 2001.

(51) Int. Cl. B42D 3/04

(52) U.S. Cl. 281/17

(57) ABSTRACT

This invention is to fold sheets of paper and cover paper from 8½ wide by 11 inchs and longer or shorter for books/booklts and such

### BACKGROUND OF THE INVENTION

This invention is to help hand fold sheets of paper and cover of paper for books/booklts and such. There are electric autofolders on the market but in my research found none to help with hand folding. The purpose of the present invention is

(1) To make hand folding sheets of paper and covers of paper easyer

(2) To make hand folding sheets of paper and covers of paper faster.

(3) To give a even and swear fold for books/booklts & such

### SUMMARY OF THE INVENTION

Folding sheets of paper and covers of paper by hand for books/booklts and such is time consuming this invention will help make folding easyer and faster to do by hand

### BRIEF DESCRIPTION OF DRAWINGS

FIG. (1) shows a top gross sectional view taken horizontally through the center of the jig of this invention also front and back view and R and L side view

FIG. (2) shows unassembled view of parts 2 and 3 befor it,s glued togeter prominently of this invention

FIG. (3) shows back part of 1—showing th enon slip liner glued to the back of part 1—of this invention

### DETAILED DESCRIPTION

Referring now to the drawings in more detail of the present invention. The easy fold jig is constructed of four parts 1-2-3-4 Part one is the bottom part of the jig. Part two is glued to the top end of part one—part 3 is glued to the top of part two—and part four is glued to the back side of part one making the jig non slip for table tops or desks.

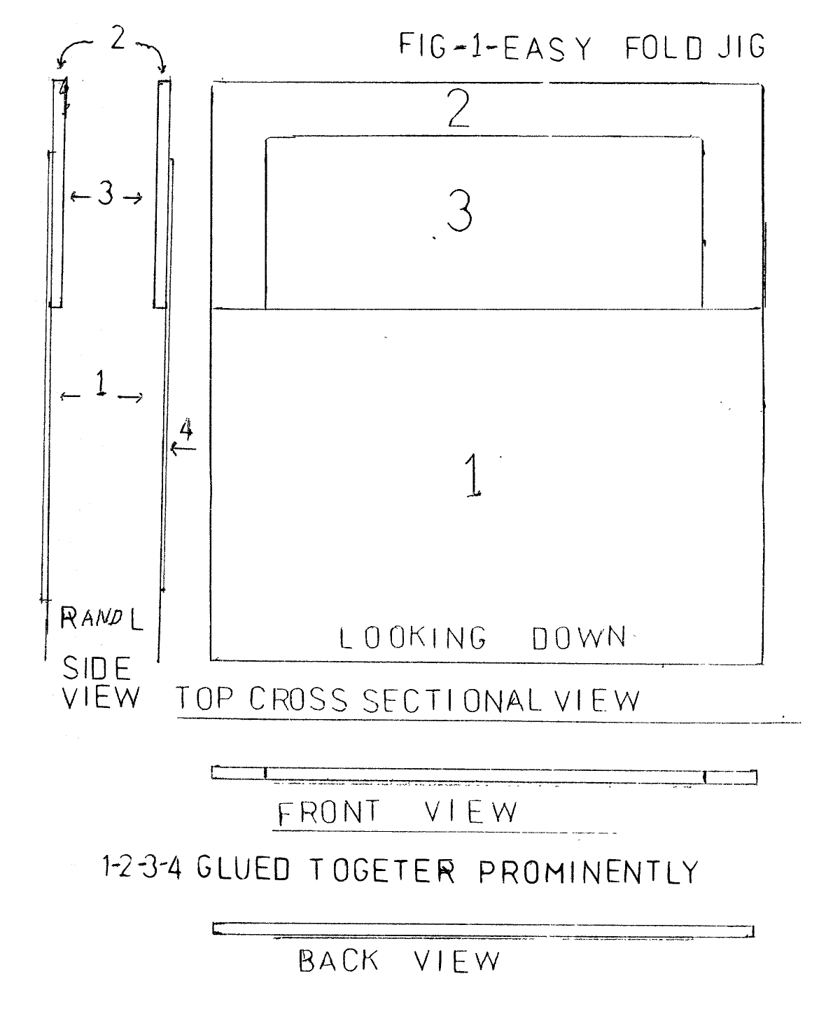

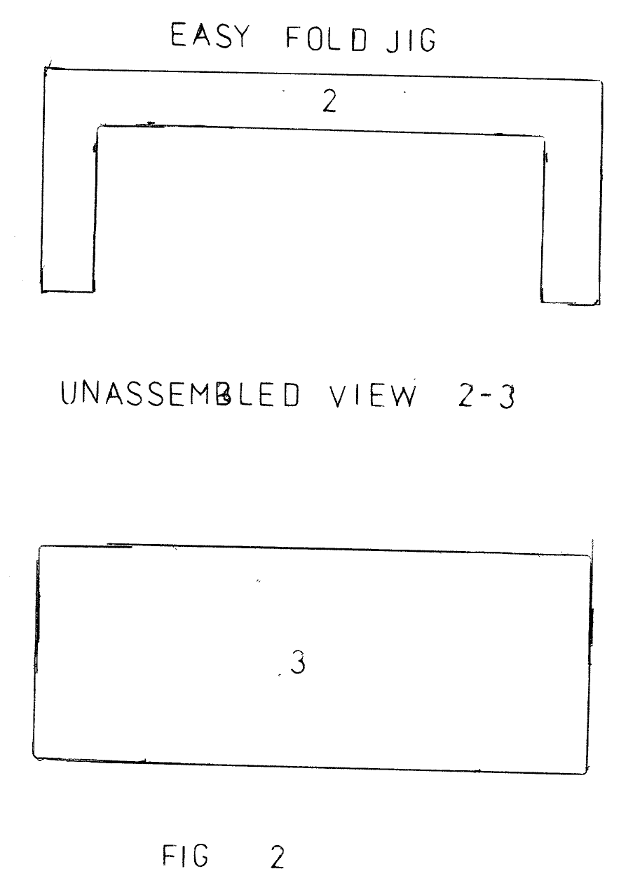

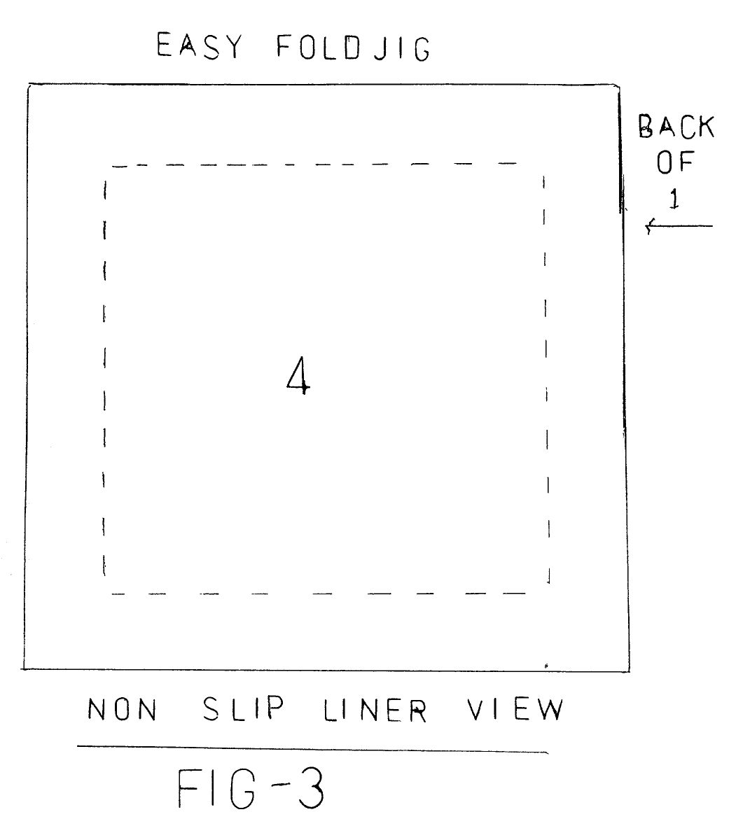

Now the easy fold jig is completely assembled and glued prominently making it one unite as showd in FIG. 1—the jig is now ready to be used. Now by geting the paper being used bringing the two ends of paper togeter sliding the two ends into the ¼″ opening under part three slide the two ends into the back and side edge of part two then holding the paper in that position and makingf the fold. An improvement to hand folding for books/booklts and such that make it easyer and faster to do by hand

1. What I clam as my invention is it will help in hand folding sheets of paper and cover of paper for books/booklts and such easyer and faster to do by hand and give a even and swear fold
